(19) United States
(12) Patent Application Publication
(10) Pub. No.: US 2024/0421553 A1
(43) Pub. Date: Dec. 19, 2024

(54) METHOD OF Q-SWITCHING A WAVEGUIDE LASER

(71) Applicant: Lastek Pty Ltd, Thebarton (AU)

(72) Inventors: Victor KARAGANOV, Thebarton (AU); Alex STANCO, Thebarton (AU)

(73) Assignee: Lastek Pty Ltd, Thebarton (AU)

(21) Appl. No.: 18/742,111

(22) Filed: Jun. 13, 2024

(30) Foreign Application Priority Data
Jun. 13, 2023 (AU) 2023901867

(51) Int. Cl. H01S 3/115; H01S 3/063

(52) U.S. Cl. CPC H01S 3/115; H01S 3/063

(57) ABSTRACT

A method of Q-switching a laser utilizing a waveguide with a strongly localised guiding region is disclosed. A laser cavity including an input pump beam, a highly reflective mirror, a waveguide gain medium, a collimating material, an electro-optic device, and an output coupler is disclosed. The electro-optic device may be an electro-optic deflector or an electro-optic scrambler. Various electro-optic deflector and scrambler geometries are disclosed which allow for Q-switching a laser. The collimating material may include one or more lenses or may instead include a metamaterial layer for appropriately collimating the input pump beam.

### TECHNICAL FIELD

The present invention relates to a method of Q-switching a laser, more particularly but not necessarily exclusively, to a method of Q-switching a waveguide laser using an electro-optic deflector and other electro-optic devices.

### BACKGROUND ART

Lasers possess significant commercial, industrial, and scientific applications. Short, intense laser pulses are crucial for numerous applications, for example but not limited to applications in tattoo removal, distance imaging, precision metal cutting, or for stimulation in chemical reactions.

A commonly used method to generate pulsed output beams, commonly referred to as ‘Q-switching’, involves the use of an optical modulator as a component within a laser oscillator to switch the Quality Factor, or ‘Q Factor’ or ‘Q’, of a resonator from ‘low’ to ‘high’ after the laser medium has been excited. This allows for the round-trip gain of the oscillator to rapidly shift from below threshold values to far above threshold values, resulting in fast build-up and emission of an intense optical pulse. This excitation and switching process may be repeated, allowing for the generation of repeated, short intense optical pulses.

For fast Q-switching of pulsed lasers, electro-optic (‘EO’) polarisation rotators based on Pockels cells are commonly used. (Koechner W. ‘Solid State Laser Engineering’, 5th Edition, 1988, p. 469). Such lasers require relatively high Q-switching voltage and additional intracavity polarising components, such as waveplates and/or polarisers to operate.

Another, less common, configuration for fast electro-optic Q-switching is known in the art, wherein the Q switch is an electro-optic Bragg modulator, based on a periodically poled lithium niobate (PPLN) crystal (Lin et al, ‘Electro-optic periodically poled lithium niobate Bragg modulator as a laser Q-switch’, OPTICS LETTERS, p.545, Vol. 32, No. 5, 2007). Although this configuration has some advantages for Q-switching, it may require the PPLN crystals to be custom designed, they are usually more expensive and may have dimension constraints.

Electro-optic deflectors have been used as a Q-switch in producing pulsed lasers. These deflectors are capable of deflecting intracavity beams in response to an applied voltage. This may be referred to as an activated deflection configuration Q-switch. The applied voltage generates an electric field across the electrodes of the deflector, with the extent of deflection proportional to the strength of the electric field. However, the deflected intracavity beam introduces a misalignment of the laser cavity, leading to high optical loss or a low-Q state. To restore the laser's performance, the electric field is deactivated, leading to the removal of optical loss and a high-Q state. The laser beam then returns to its original path, producing a high-energy pulse at the laser output.

Another configuration for Q-switching is known in the art, wherein an output coupler is arranged such that the deflected beam is misaligned to the laser cavity. In this configuration, the removal of the applied voltage restores the direction of the beam, aligning the beam with the output coupler thereby Q-switching the beam to produce a pulsed laser output. This arrangement does not require a high-quality deflected beam, as the deflection only acts to misalign the beam within the cavity. In contrast, the ‘activated deflection’ configuration requires a high-quality deflected beam to produce a high-quality output pulsed beam.

The use of an electro-optic deflector as the optical modulator in Q-switching applications have been explored in the art. Ley et al. (U.S. Pat. No. 7,742,508, ‘ELECTRO-OPTIC DEFLECTOR’, 22 Jun. 2010), discloses using an electro-optic deflector as a Q-switch in the production of nanosecond pulsed lasers, with Friel et al. (‘Q-switching of a diode-pumped Nd:YVO₄ laser using a quadrupole deflector’, Appl. Phys. B, p 267-270, Vol 67, 1998) and Horiuchi et al. (‘1.4-MHz repetition rate electro-optic Q-switched Nd:YVO₄ laser’, Optics Express, p 16729-16734, Vol 16, No. 21, 2008) further disclosing the use of a quadrupole electro-optic deflector in Q-switching a laser.

There are several issues associated with previously reported Q-switching systems that use an electro-optic deflector as the Q-switch. First, relatively high voltages are required to introduce beam deflection sufficient to hold off laser oscillation. Second, a strongly localised laser gain region is required for application in electro-optic deflectors in Q-switching, as otherwise, significant voltages are required to sufficiently deflect the laser beam. The system disclosed by Friel et al. utilises a localised gain and guiding region associated with the tight pump spot.

Q-switched lasers that utilize electro-optic deflectors as the Q-switch face numerous issues. A significant challenge pertains to the high voltage requirements necessary to generate beam deflection sufficient to prevent laser oscillation. Additionally, a tightly confined pump beam is necessary for effective operation of the conventional solutions. When the pump laser spot is not tightly confined, the Q-switching becomes less responsive to deflection from the applied electric field, necessitating the application of higher voltages, which may not be feasible outside of laboratory conditions. Furthermore, deflection of the beam, as any cavity misalignment, may force the laser to switch to a higher spatial mode and/or emit the beam in a different direction instead of performing Q-switching. Preventing operating at higher spatial modes may represent a significant challenge in design of such lasers.

Friel et al. discloses a method for deflecting the laser beam through the application of an applied voltage of 400V, and a laser that utilises a localized gain region to achieve a confined beam, a setup of which is illustrated in FIG. 1. They reported a pump beam spot size of approximately 120 μm (1/e² diameter). As discussed above, the drawbacks of such a system include the need for high Q-switching voltage and the laser tendency to lase at higher spatial modes instead of effectively performing Q-switching. Thus, solutions are required that efficiently produce a laser compatible for use with an electro-optic deflector in Q-switching applications, while enabling the miniaturization of Q-switched laser systems without compromising their performance or reliability, or simplicity of design.

Prior art has explored methods for manufacturing lasers with a tightly confined intracavity beam. Lancaster et al. (U.S. Pat. No. 8,837,534, ‘ELEMENT FOR THE AMPLIFICATION OF A LIGHT AN METHOD OF MAKING THE SAME’, 16 Sep. 2014) and Palmer et al. (‘High slope efficiency and high refractive index change in direct-written Yb-doped waveguide lasers with depressed claddings’ OPTICS EXPRESS, 2013, Vol. 21, No. 14, p 17413) have demonstrated the use of a waveguide as the gain medium for a laser to create a tightly confined ‘waveguide laser.’

A critical advantage of using a waveguide as the gain medium is that the gain medium itself has the ability to appropriately confine the laser beam. A waveguide contains a strongly localised guiding region, which produces a diffraction limited output beam. Waveguides and their strongly localised guiding region are known in the art, an example of which is provided in FIGS. 2a and 2b for reference.

To date, the utilisation of a waveguide laser in conjunction with an electro-optic deflector to produce a Q-switched pulsed laser has yet to be accomplished. However, the realisation of this possibility would provide a critical functional advantage, such as the ability to create a Q-switched laser using an electro-optical deflector that naturally operates only at the fundamental TEM00 mode due to the confined size of the waveguide core. This would allow the development of a laser with lower voltage requirements and greater design simplicity.

Although a conventional deflector Q-switch has a number of advantages for laser applications, the main downside is a relatively high driving voltage. Depending on the deflector geometry and dimensions, the required voltage is typically in the range of 100V-500V for compact devices. For example, to achieve a beam deflection θ in a quadrupole LiNbO₃ deflector the required voltage V is determined by the following relationship (Lotspeich J. F. ‘Electrooptic Light-Beam Deflection’, IEEE Spectrum, p. 45-52, February 1968):

$$θ = ( \frac{{Ln}_{0}^{3} {r}_{33}}{2 {w}^{2}} ) V$$

where L is the deflector length, w is the radius of deflector limiting aperture and n₀ and r₃₃ are the LiNbO₃ refractive index and electro-optic coefficient. A schematic diagram illustration laser deflection θ is illustrated in FIG. 3a. FIGS. 4a and 4b illustrate the electric field distribution for such a deflector. It should be noted however, that the above equation is derived specifically for the quadrupole deflector design and for the conditions where the electric field gradient is required to be uniform across the entire clear aperture of the deflector. The uniform field gradient distribution is essential to maintain high quality of the deflected beam.

However, if the requirement for maintaining the beam quality and consequently for the field uniformity are removed, different more efficient geometries of the electro-optic arrangement and field distribution can be utilised. In such cases the EO device may no longer work as a beam deflector, instead it will affect the beam spatial structure.

If the beam passes through the regions with a strong and nonuniform electric field gradient, the beam shape will deteriorate in a variety of ways, including deflection of the entire beam or particular segments of the beam, diffraction, splitting the beam, focusing or defocusing parts of the beam, and other similar effects.

It is an aspect of the present invention to overcome or ameliorate a problem of the prior art by providing an improved method for Q-switching a laser using an electro-optic deflector in conjunction with the advantages of a waveguide as the gain medium. It is a further aspect to provide an alternative to prior art methods for Q-switching a laser using electro-optic deflectors. It is a further aspect of the invention to provide a novel approach for Q-switching, whereby an EO device introduces intracavity losses by altering (deteriorating) the spatial profile of the beam in a process referred to as “scrambling”.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the invention comprises a system for Q-switching a laser comprising: an input pump beam; a laser cavity comprising a high reflectivity cavity mirror (HR mirror), a waveguide gain medium, a collimating material, an electro-optic deflector, and an output coupler; wherein the waveguide comprises a strongly localised guiding region; wherein the input pump beam is passed through the waveguide, pumping the gain medium. When the laser is lasing, the intracavity laser beam is passed through the collimating material prior to being passed through the deflector; wherein the output coupler is arranged such that in the absence of an applied voltage to the deflector the intracavity beam is misaligned to the laser cavity; and wherein upon an applied voltage to the deflector, the intracavity beam is deflected to become aligned with the output coupler producing a pulsed output beam.

In an embodiment the output coupler is arranged such that in the presence of an applied voltage to the deflector, the intracavity beam is deflected to be misaligned to the laser cavity; and wherein upon the removal of the applied voltage to the deflector, the intracavity beam becomes aligned with the output coupler producing a pulsed output beam.

In an embodiment, the system comprises a plurality of input pump beams and a plurality of waveguide gain mediums; wherein the plurality of waveguide gain mediums produce a plurality of intracavity beams; and wherein the plurality of intracavity beams are passed through the deflector.

In an embodiment, the deflector comprises a repeating pattern of electrodes, wherein each unit of the repeating pattern of electrodes are aligned with an individual intracavity beam, and wherein when the plurality of intracavity beams are passed through the deflector an array of pulsed output laser beams is produced.

In an embodiment, the collimating material is a collimating lens.

In an embodiment, the collimating material is a metamaterial layer.

In an embodiment, the collimating material is a plurality of metamaterial layers.

In an embodiment, a diameter of the strongly localised guiding region of the waveguide gain medium is on the order of 10 μm.

In an embodiment, the electro-optic deflector is a quadrupole electro-optic deflector.

In an embodiment, the electro-optic deflector comprises cylindrical electrodes.

In an embodiment, the electro-optic deflector comprises flat or rectangular electrodes.

In an embodiment, in the presence of an applied voltage the electro-optic deflector comprises a plurality of regions with high electric field gradient.

In an embodiment, the plurality of high electric field gradient regions are used to deflect the intracavity beam.

In another aspect, the invention comprises a method of producing a Q-switched laser, the method comprising: passing an input pump beam through a gain medium; wherein the gain medium is a waveguide with a strongly localised guiding region; wherein passing the input pump beam through the gain medium produces an intracavity laser beam; passing the intracavity beam through a collimating lens into an electro-optic deflector; applying a pulsed voltage to the deflector to deflect the intracavity beam; wherein the deflected intracavity beam is aligned with an output coupler to produce a pulsed output beam.

In yet another aspect, the invention comprises a method of producing a Q-switched laser, the method comprising: passing an input pump beam through a gain medium; wherein the gain medium is a waveguide with a strongly localised guiding region; wherein passing the input pump beam through the gain medium produces an intracavity laser beam; passing the intracavity beam through a collimating lens into an electro-optic deflector; applying a voltage to the deflector to deflect the intracavity beam; wherein the deflected intracavity beam is misaligned within a laser cavity; and wherein upon the removal of the applied voltage to the deflector, the intracavity beam is aligned with the output coupler to produce a pulsed output beam.

In an embodiment, the method comprises a plurality of input pump beams and a plurality of waveguides to produce a plurality of intracavity beams.

In an embodiment of the method, the deflector comprises a repeating pattern of electrodes, wherein each unit of the repeating pattern of electrodes are aligned with an individual intracavity beam, and passing the plurality of intracavity beams are through the deflector producing an array of pulsed output laser beams.

In an embodiment, the method further comprises identifying regions of high electric field gradient within the electro-optic deflector; and passing the plurality of intracavity beams through the regions of high electric field gradients for deflection.

In an embodiment of the method, the collimating lens formed from a metamaterial layer.

In an embodiment of the method, the collimating lens is formed from a plurality of metamaterial layers.

In another aspect, the invention comprises a system for Q-switching a laser comprising: an input pump beam; a laser cavity comprising a high reflectivity cavity mirror (HR mirror), a gain medium, an optional collimating material, an electro-optic beam “scrambler”, and an output coupler; wherein the input pump beam is pumping the gain medium. The output coupler is arranged such that in the presence of an applied voltage to the “scrambler”, the intracavity beam is scattered to be misaligned to the laser cavity; and wherein upon the removal of the applied voltage to the deflector, the intracavity beam becomes aligned with the output coupler producing a pulsed output beam.

In another aspect, the invention comprises a system for Q-switching a laser (comprising: an input pump beam; a laser cavity comprising a high reflectivity cavity mirror (HR mirror), a waveguide gain medium, a collimating material, an electro-optic “scrambler”, and an output coupler; wherein the waveguide comprises a strongly localised guiding region; wherein the input pump beam is passed through the waveguide, pumping the gain medium. When the laser is lasing, the intracavity laser beam is passed through the collimating material prior to being passed through the deflector. The output coupler is arranged such that in the presence of an applied voltage to the “scrambler”, the intracavity beam is scattered to be misaligned to the laser cavity; and wherein upon the removal of the applied voltage to the deflector, the intracavity beam becomes aligned with the output coupler producing a pulsed output beam.

In an embodiment, an electro-optic “scrambler” comprises a rectangular electro-optic crystal with planar electrodes deposited on the surface or attached to the surface.

In an embodiment, an electro-optic “scrambler” comprises a rectangular electro-optic crystal with sharply edged electrodes attached to the surface.

In an embodiment of the method, the laser beam is directed through the EO crystal at a shallow grazing angle to the crystal surface where the electrodes are located in

In an embodiment of the method, the laser beam has an elliptical spatial profile with the major axis of the ellipse oriented parallel to crystal surface.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows schematic diagram of a prior art laser utilising a deflector as a Q-switch;

FIG. 2a and FIG. 2b shows a waveguide core surrounded by regions of lower refractive index;

FIG. 3a shows a schematic view of beam deflection;

FIG. 3b shows a schematic view of beam scrambling;

FIG. 4a illustrates a cross-sectional view of a prior art quadrupole EO deflector with a calculated spatial distribution of the electric field, otherwise known as equipotential lines, for a ±5V applied voltage;

FIG. 4b shows a graph indicating the variation in the electric field and electric field gradient along the x-axis of the deflector of FIG. 4a;

FIG. 5a illustrates a schematic diagram of a waveguide laser utilising a deflector as a Q-switch according to a preferred embodiment of the invention;

FIG. 5b illustrates a schematic diagram of a waveguide laser utilising a deflector as a Q-switch according to another preferred embodiment of the invention;

FIG. 6a illustrates a cross-sectional view of a EO scrambler comprising sharp edged planar electrodes attached to the crystal surface with a calculated spatial distribution of the electric field (equipotential lines) for a ±5V applied voltage;

FIG. 6b shows a graph indicating the variation in the electric field and electric field gradient along the x-axis of the deflector of FIG. 6a;

FIG. 7 illustrates a performance comparison of three EO schemes for Q-switching;

FIG. 8 illustrates two waveguides produced on a single waveguide glass;

FIG. 9a illustrates a cross-sectional view of a quadrupole EO deflector based on a rectangular EO crystal with planar electrodes deposited on the crystal surface and with a calculated spatial distribution of the electric field (equipotential lines) for a ±5V applied voltage;

FIG. 9b shows a graph indicating the variation in the electric field and electric field gradient along the x-axis of the deflector of FIG. 9a;

FIG. 10a illustrates a cross-sectional view of a rectangular EO scrambler with planar electrodes deposited on the crystal surface with a calculated spatial distribution of the electric field (equipotential lines) for a ±5V applied voltage;

FIG. 10b shows a graph indicating the variation in the electric field and electric field gradient along the x-axis of the deflector of FIG. 10a;

FIG. 11 demonstrates the far field profile of the beam, emergent from the EO scrambler, with and without a voltage applied to the scrambler;

FIG. 12 is a schematic view of an optical arrangement for an electro-optic beam scrambler, based on a rectangular EO crystal with several sharp edged electrodes attached to the crystal surface, operating at a small grazing angle;

FIG. 13 is a schematic diagram of a waveguide laser utilising a beam scrambler as a Q-switch; and

FIG. 14 shows a graph of an oscilloscope screenshot which demonstrates the shape of an optical pulse and shape of the Q-switch driver voltage applied to the deflector.

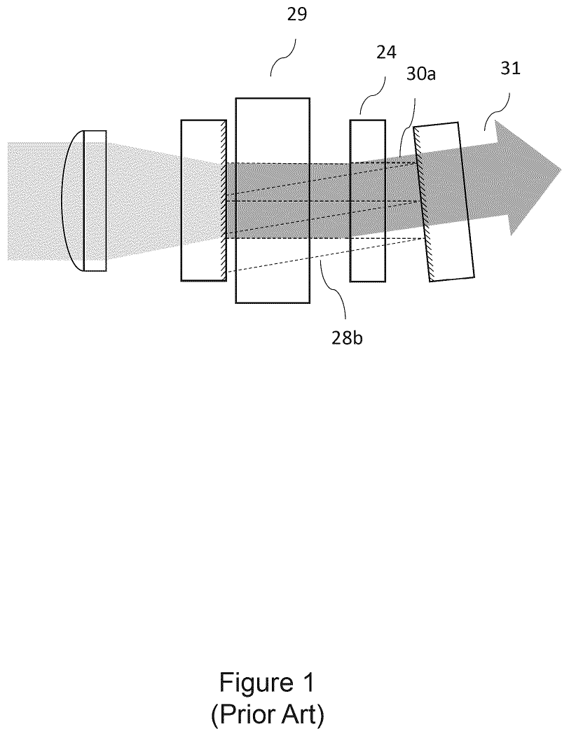

### LIST OF COMPONENTS

The drawings include items labelled as follows:
12—pump beam
14—cavity HR mirror
16—waveguide
18—waveguide core
20—intracavity beam
22—intracavity collimating lens
24—electro-optic deflector Q-switch
26—cavity output coupler
28a—non-deflected beam (high-Q)
28b—non deflected beam (low-Q)
29—laser gain bulk crystal
30a—deflected beam (high-Q)
30b—deflected beam (low-Q)
31—output beam (high-Q)
32—uniform electric field gradient region
33—scattered beam (low-Q)
36—high non-uniform electric field gradient region
38—waveguide array
39—non-scattered beam (high Q)
40—waveguide glass
41—electro-optic beam scrambler Q-switch
42—waveguide element
44—waveguide element
45—waveguide cladding (regions of lower refractive index)
46—electro-optic crystal
48—electrode assembly attached to the electro-optic crystal
50—3 mrad diameter region in the far field

### DETAILED DESCRIPTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

In one preferred embodiment, the present invention provides an improved method of Q-switching a laser using an electro-optic deflector that addresses the limitations of the prior art. The present embodiment of the invention utilises a waveguide as the gain medium in a Q-switching laser system. The waveguide possesses a strongly localised guiding region. This feature allows implementation of a deflector Q-switched laser that naturally operates only at the fundamental TEM00 mode (the lowest-order transverse mode) due to the confined size of the waveguide core. This would allow the development of a deflector Q-switched laser with lower voltage requirements and greater design simplicity.

The use of a waveguide as the gain medium overcome issues associated with the prior art, wherein typical bulk crystal gain elements, such as Nd:YVO₄, do not naturally possess any such strongly localised gain region. Therefore such a laser instead of Q switching by a deflector may be switching to higher spatial modes. Higher voltage for deflection of the beam in the electro-optic deflector may be required to ensure reliable Q switching in such systems.

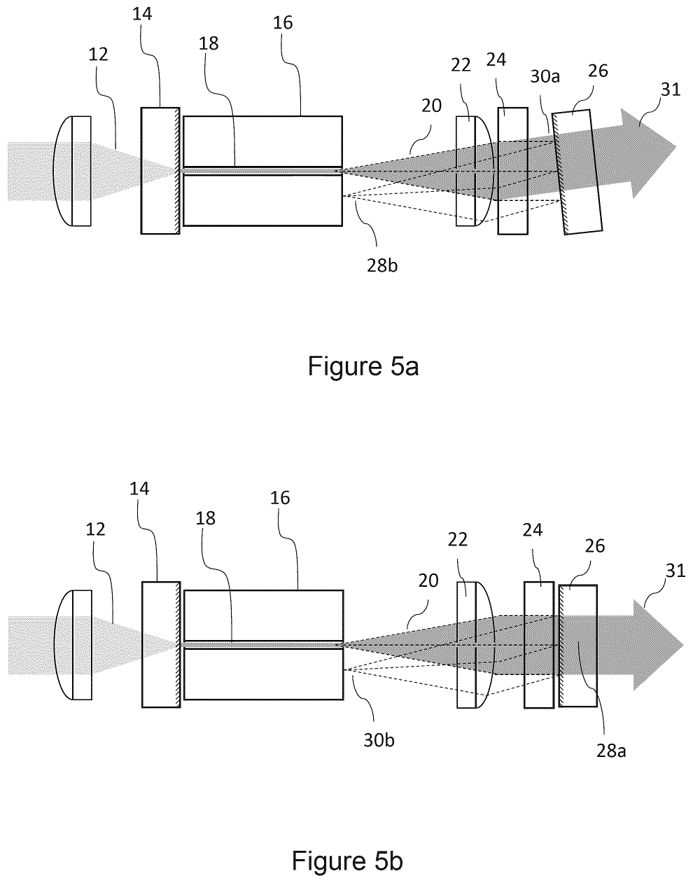

Referring now to FIG. 5a,a schematic diagram of the laser cavity of a an embodiment of the invention is illustrated. A waveguide is used as a gain medium to produce a waveguide laser for use with an electro-optic deflector for Q-switching applications. A pump diode produces a pump beam 12, which first passes through the HR cavity mirror 14 then through waveguide 16 with waveguide core 18 that acts as a strongly localised guiding region. The core region 18 may have a diameter of approximately 10-20 μm, although it is not limited to such as size. The waveguide-emergent beam 20 passes through a collimating lens 22 with a focal length of approximately 1-3 mm, and enters the electro-optic deflector, or Q-switch, 24. The deflector 24 comprises electrodes (not pictured) which, in response to an applied voltage varies the electric field within the deflector.

Within the deflector, in the absence of an applied voltage, the beam is incident on the partially reflective output coupler mirror 26 causing the beam to reflect back from the output coupler, producing a misaligned beam 28b to the laser cavity (low Q state). An applied voltage to the deflector imposes a deflection to the internal beam, effecting a change from a low-Q state to a high-Q state, producing a high-Qbeam 30a, which emerges as a pulsed output beam 31. This configuration applies a voltage to the deflector in order to deflect the beam to be aligned with the output coupler (high Q state), producing a pulsed laser beam output.

In a second embodiment illustrated in FIG. 5b, the output coupler 26 is positioned perpendicular to the direction of travel of the internal beam. In this configuration, a constant applied voltage to the deflector 24 deflects the internal beam such that the beam, when reflected at the output coupler 26, produces a beam 30b that is misaligned to the laser cavity (low Q state). The applied voltage may then be removed, aligning the internal beam with the output coupler to produce high-Q state beam 28a and producing a pulsed laser beam output 31. In this configuration, the removal of the applied voltage effects a change from a low-Q state to a high-Q state. In this configuration, the role of the applied voltage is to deflect the beam such that it is misaligned within the laser cavity. This requires a deflected beam that is much less precise and allows for a lower deflected beam quality than in the first configuration.

The pump beam 12 generated by the pump diode typically has wavelength of approximately 976 nm when Yb doped: ZBLAN glass is used as a gain media, however it is not limited to such a wavelength. The pump beam 12 may be directed towards the waveguide through methods such as, but not limited to the use of fibre optic cables and focusing lens. The diameter of the focused pump beam 12 is approximately the diameter of the waveguide core.

The cavity HR mirror 14 is highly reflective at the laser wavelength and transmissive at the pump wavelength.

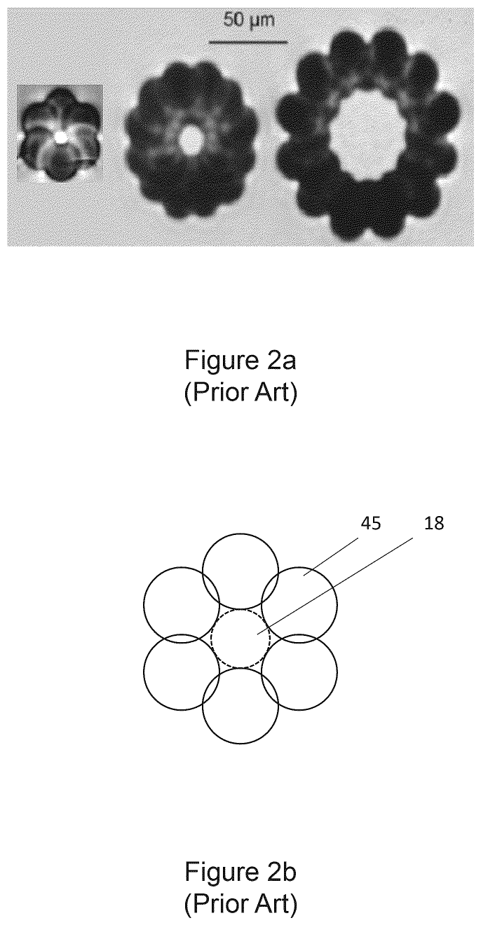

The waveguide 16 used in the present embodiment of the invention are typical waveguides known in the art, such as Yb:ZBLAN glass waveguides taught by Palmer et al., however, the method of the invention is not limited to utilising said Yb-doped waveguides. Any waveguide that simultaneously acts as a gain medium and possesses a strongly localised guiding region may be used. The waveguide core 18 may have a diameter of approximately 10-20 μm, although it is not limited to such as size. FIGS. 2a and 2b illustrates a typical structure of the waveguide core 18. Such a waveguide in ZBLAN may be formed by modification of its refractive index, as is known in the art. Waveguide core 18 may be surrounded by regions of lower refractive index 45, which forms a waveguide cladding. Examples of waveguides which may be used include waveguides known in the art as produced by RedChip Photonics Pty Ltd, Macquarie University, and others, in Australia. Such waveguides include, but are not limited to Ytterbium-based waveguides, Erbium-based waveguides, Thulium-based waveguides, or Holmium-based waveguides.

The small core region 18 of the waveguide 16 of approximately 10-20 μm produces an intracavity beam 20 which, once collimated through the collimating lens 22 along the length of the deflector 24, could be on the order of 100-500 μm.

The peak output power is generally determined by the pump power, pulse repetition rate, reflectivity of applied coatings, or other factors. The maximum peak power of the output beam 31 is limited by the optical damage threshold of the waveguide 16.

In a preferred embodiment of the invention, electro-optic deflector 24 may be a quadrupole electro-optic deflector with cylindrical electrodes, as this geometry provides a uniform field gradient distribution across the entire aperture of the deflector (0.5 mm). Typically, the electrodes are composed of, but are not limited to, a conductive coating applied to the sides of a LiNbO₃ crystal. The LiNbO₃ deflector is capable of deflecting and therefore Q-switching at a range of wavelengths within an approximate range between 0.4 μm to 4.4 μm.

The output end of the deflector 24 may be coated with an anti-reflective (AR) coating at the desired output wavelength. Advantages of applying an AR coating are known in the art, and include improving the optical transmission, increasing throughput of the system, and reducing optical insertion losses.

In another embodiment of the invention, output end of the deflector 24 may comprise a mirrored coating applied on an output face of the deflector that simultaneously functions as a partially reflective mirror and output coupler. This embodiment of the invention does not need a separate output coupler 26.

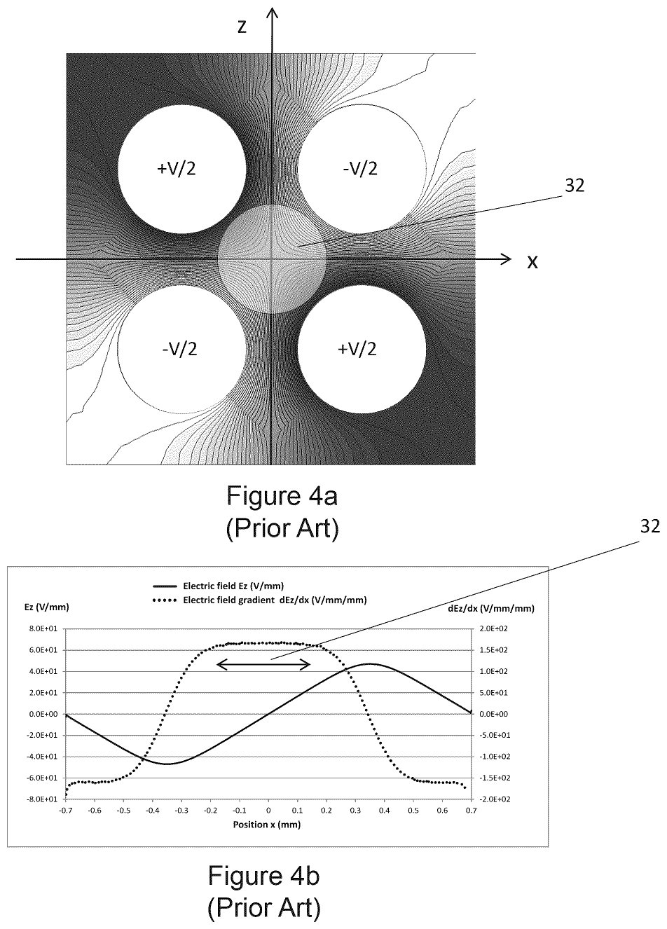

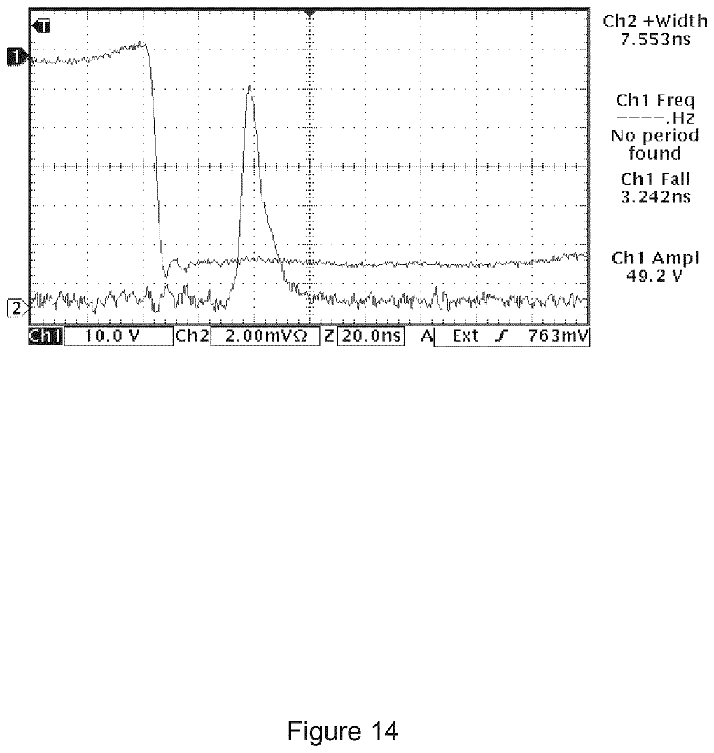

Applicant has constructed a Q-switched laser comprising a waveguide with a core diameter of 10 μm and a 5 mm long quadrupole deflector such as in FIG. 4a with a clear aperture of 0.5 mm. Q-switched operation was achieved across a range of repetition rates and Q-switch voltages. As an example, FIG. 14 illustrates the laser operation at 5 kHz using a Q-switch voltage of 50V, indicating successful Q-switching.

The second embodiment of the invention depicted in FIG. 5b, offers several advantages over the first embodiment shown in FIG. 5a as disclosed in U.S. Pat. No. 7,742,508. The first embodiment necessitates the preservation of a high-quality, undistorted deflected beam, which requires the deflector to have an area with a highly uniform electric field gradient. This uniform field must be of a size comparable to that of the intracavity beam. In previous designs, the uniform field was achieved at the centre 32 of a quadrupole deflector with hyperbolic or cylindrically shaped electrodes, as shown in FIGS. 4a and 4b. These figures demonstrate the uniform electric field gradient within the centre of the quadrupole deflectors. These deflector geometries are difficult to produce and manufacture, leading to potential issues in the Q-switching system. In contrast, the second embodiment with an undeflected output beam does not require a high-quality deflected beam, and therefore, the requirement for uniformity of the electric field gradient across the deflector can be relaxed.

In the present invention, the relaxed requirement for the deflected beam quality in the second configuration allows for further simplification of the deflector 24 geometries and design. This simplification allows for deflectors with rectangular electrodes, flat electrodes, or conductive coatings as electrodes on flat surfaces instead of hyperbolic or cylindrically shaped electrodes, which are easier to produce.

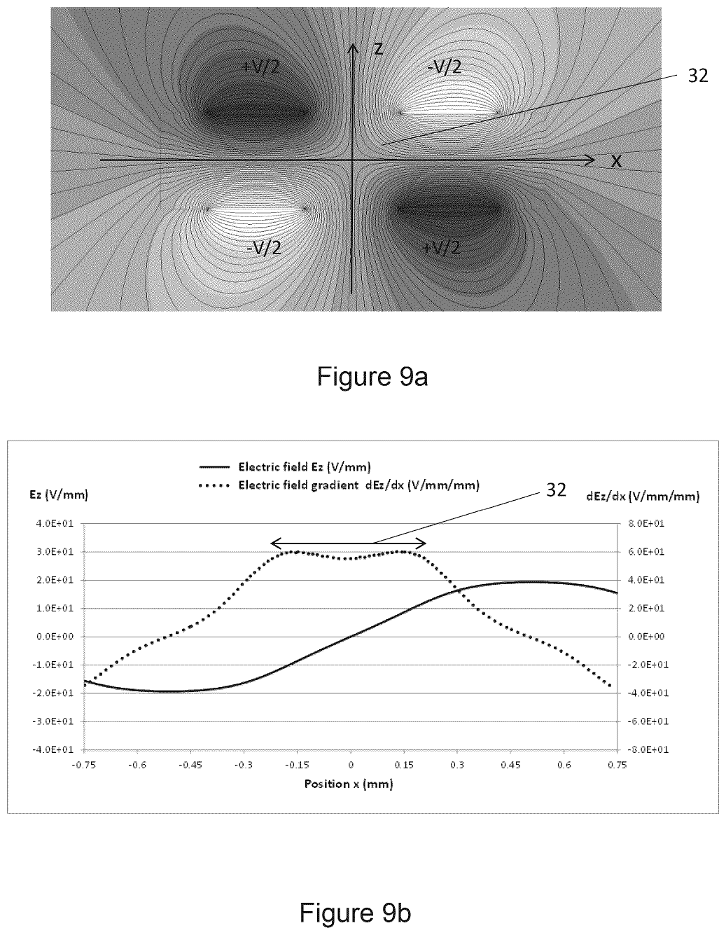

FIG. 9a illustrates a cross-section of an EO deflector with a rectangular EO deflector crystal with planar electrodes deposited on the crystal surface, comprising a uniform electric field gradient region 32. FIG. 9b illustrates a graph of the electric field and its gradient, calculated from a ±5V applied voltage.

Furthermore, these geometries may possess localised areas with a high electric field gradient 36. Although these field distributions may be nonuniform, it is still possible to use these spots for Q-switching in the second embodiment of the invention due to the relaxed requirement for the deflected beam quality. As these areas possess a high electric field gradient, it would be possible to sufficiently deflect the beam with a lower applied voltage, further reducing the Q-switching voltage required.

Further advantages in the use of a deflector as a Q-switch include eliminating the requirement for an intracavity polarising element such as a polariser and/or waveplate, while still allowing the beam to be Q-switched with the electro-optic deflector. The absence of an intracavity polarising element allows for a shorter laser cavity and an overall more compact laser. Further advantages of a shorter laser cavity include the ability to produce shorter laser output pulses and therefore higher peak power pulses. Such higher peak power pulses present significant advantages for use in non-linear optical processes, such as but not limited to use in frequency-mixing processes, Raman amplification, or in cross-phase modulation.

These electrode arrangements within the deflector comprise multiple regions with a high electric field gradient 36 capable of deflecting a beam with a low applied voltage. This plurality of regions 36 allow for a single deflector to deflect a plurality of beams from a waveguide array comprising a plurality of waveguides. The plurality of waveguides must be arranged to produce emergent beams 20 corresponding to the arrangement of the high electric field gradient regions 36.

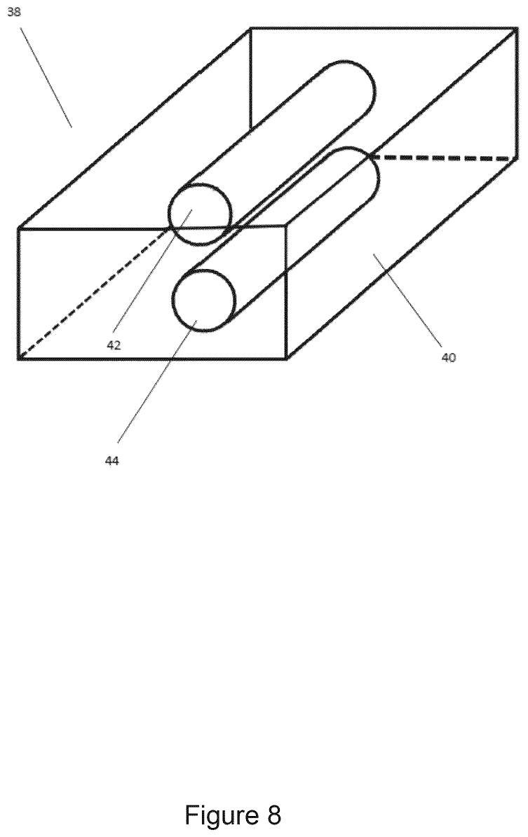

Multiple waveguides may be produced within a single bulk material, such as but not limited to doped ZBLAN glass, similar doped glasses, as illustrated in FIG. 8, or doped optical fibres (not pictured). Two waveguides elements 42, 44 are produced within a single bulk waveguide glass 40. Such a waveguide array 38 may be produced in the doped glass through a femtosecond laser through methods known in the art.

The laser power generated by waveguide lasers is restricted due to the compact dimensions of the waveguides and the beams they produce, as well as limitations imposed by their damage thresholds. However, constructing an array comprising of a plurality of waveguides permits the output power to be multiplied up. By arranging the waveguide beams effectively to match the regions of high electric field gradient, a condensed configuration is achieved to increase the lasing output of an electro-optic deflector Q-switch waveguide laser.

In another embodiment of the invention, the collimating lens 22 may instead be a metamaterial layer. Metamaterials with sub-wavelength periodicity may be designed to achieve a desired index of refraction capable of deflecting electromagnetic radiation in the same manner as lenses. A plurality of metamaterial layers may also be used designed to manipulate electromagnetic waves as desired. Metamaterials and their properties including their interaction with electromagnetic waves are common knowledge in the art.

Metamaterials may be desirable in the embodiment of the invention comprising of a waveguide array. Instead of a plurality of collimating lenses, a single metamaterial layer may be engineered to achieve the desired refraction indices to align the waveguide array beams with the high field gradient regions 36. Utilising a single metamaterial layer for collimating a plurality of beams emerging from a waveguide array presents advantages over the use of multiple collimating lenses. It offers greater ease of manufacturing and eliminates the need for meticulous alignment requirements.

In an alternate construction of the deflector, the deflector may be constructed to include a repeating pattern of electrodes, coupled to an array of waveguides using a metamaterial layer as the collimating optics. This construction of the deflector produces a dense array of Q-switched lasers as the output. Multiple electrodes may be applied to a single deflector crystal, allowing for an alignment to a linear array of emitters.

In this arrangement, the electrodes on the deflector are aligned to the output beams from the array of waveguides. Each ‘unit’ of the repeating pattern is aligned with a waveguide beam and is individually capable of producing a pulsed output laser. The matching the layout between the electrodes of the deflector and the array of waveguides allows each waveguide beam to be individually Q-switched, thereby producing a dense array of Q-switched lasers. This configuration allows the invention to be scaled to produce a desired output power of the system.

The array of deflector Q-switches, and subsequently the array of output Q-switched lasers, may also be extended to two dimensions. Multiple deflector crystals, each deflector comprising a plurality of electrode structures, may be mounted vertically adjacent to each other with appropriate electrical insulation between each deflector. Therefore, whereas the plurality of electrodes within a deflector produces a linear array of deflectors, a plurality of deflectors extends the array to two dimensions. This method of producing a two-dimensional Q-switching array allows the system to be scaled to produce appropriately powerful output beams for a desired purpose.

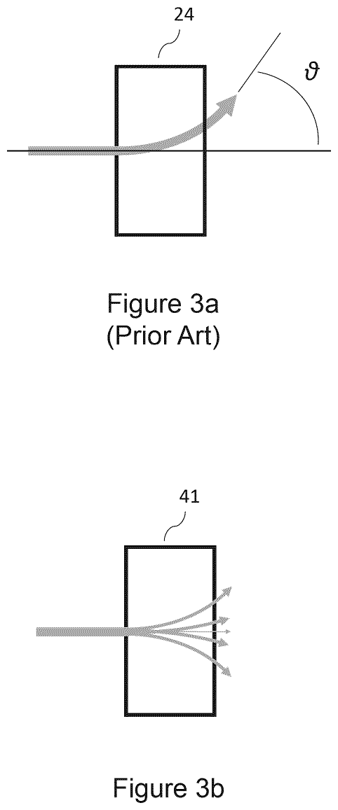

The present invention also provides a novel approach for Q-switching, based on using an EO device that introduces intracavity losses by altering or deteriorating the spatial properties of the beam, referred to as “scrambling”. FIG. 3b illustrates the operation principles of an scrambling EO device 41, whereby instead of a laser beam being deflected 0 degrees as illustrated in FIG. 3a, the scrambling EO device 41 instead spoils the spatial properties of the beam.

In the presence of a strong nonuniform electric field across the scrambling EO crystal, it is possible to effectively “scramble” the spatial beam profile. In this case, the voltage required for effective Q-switching would be substantially lower compared with the conventional Q-switches such as Pockels cell or EO deflectors.

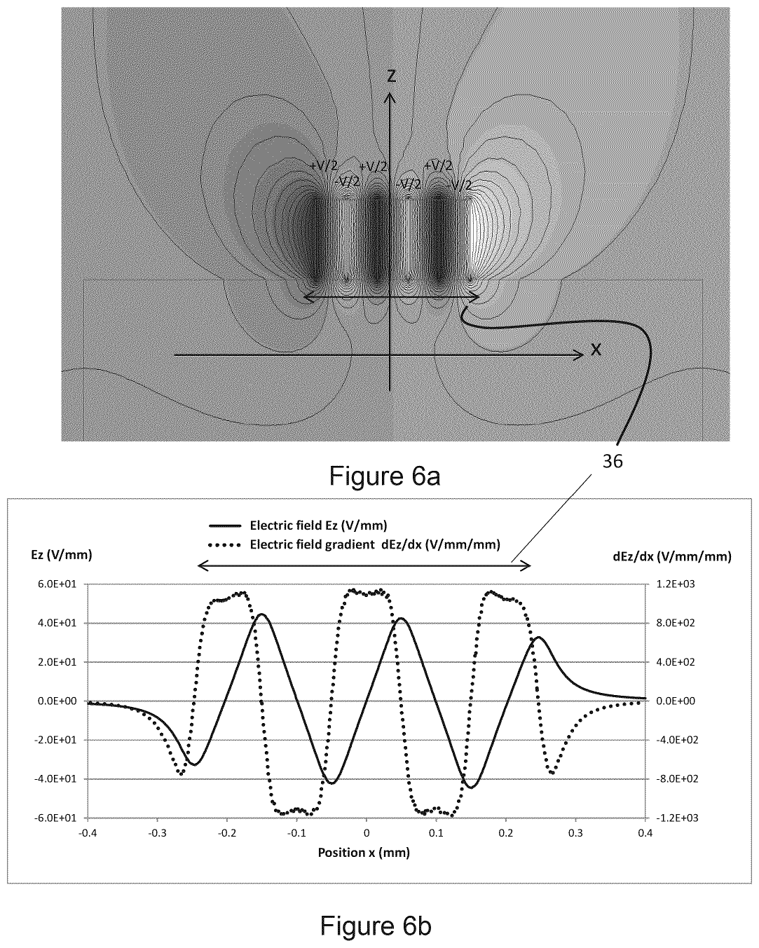

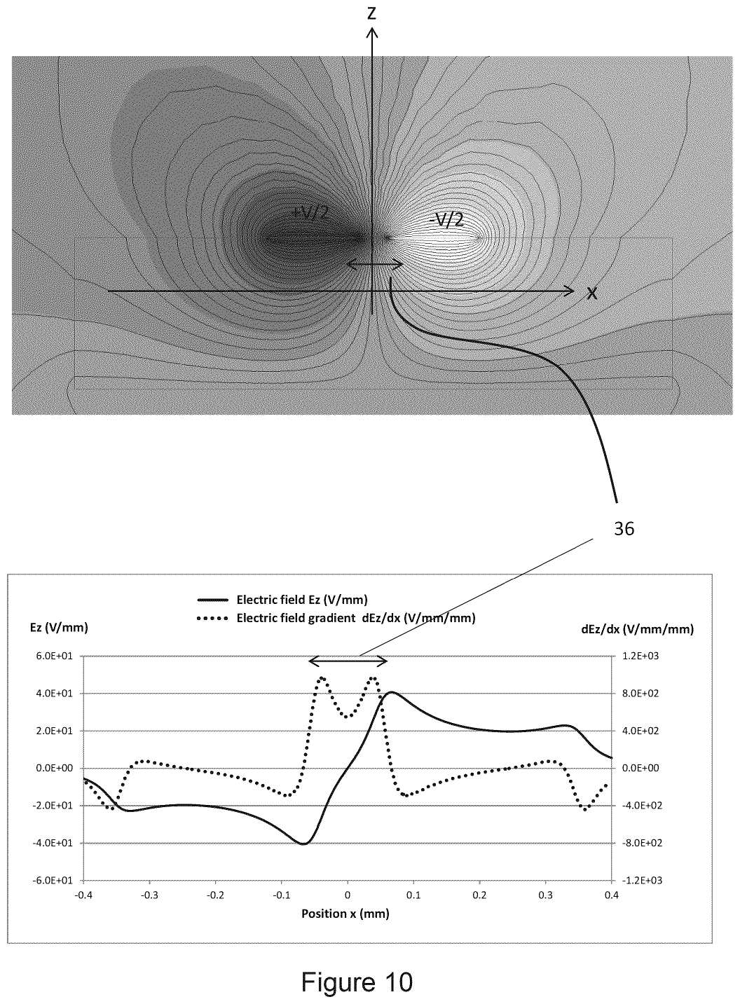

Applicant has identified that the strong non-uniform electric field gradient regions 36 as illustrated in FIGS. 6a and 6b and in FIG. 10 are capable of being used to effectively scramble the spatial beam profile for use in effective Q-switching.

FIG. 6a illustrates a cross-section view of a beam scrambler, based on a rectangular E-O crystal with several sharp-edged electrodes attached to the crystal surface. The calculated field distribution shows the areas with high field gradient. FIG. 6b illustrates a graph of the electric field and its gradient, calculated for a ±5V applied voltage.

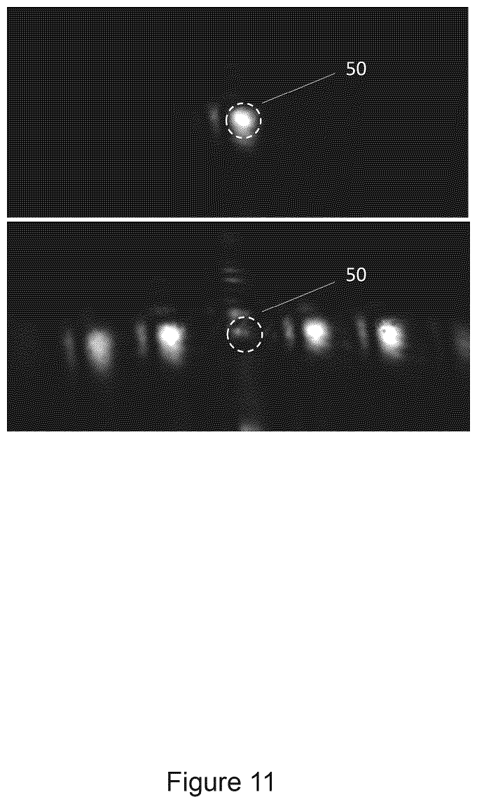

FIG. 11 compares the performance of an EO beam scrambler with a conventional transverse Pockels cell. The top image shows the profile of the beam when no voltage is applied to the E-O scrambler. The bottom image shows the profile of the scattered beam when 30V is applied to the E-O scrambler. The dashed circles regions represent the Airy disk 50 of the beam scrambling device used in the demonstration. The graph shows the calculated single pass transmission for a Pockels cell as well as the transmission measurement results for the EO beam scrambler. For the purpose of comparison, it is assumed that the devices are based on a LiNbO₃ crystal and equidimensional (0.5 mm×0.5 mm×5 mm).

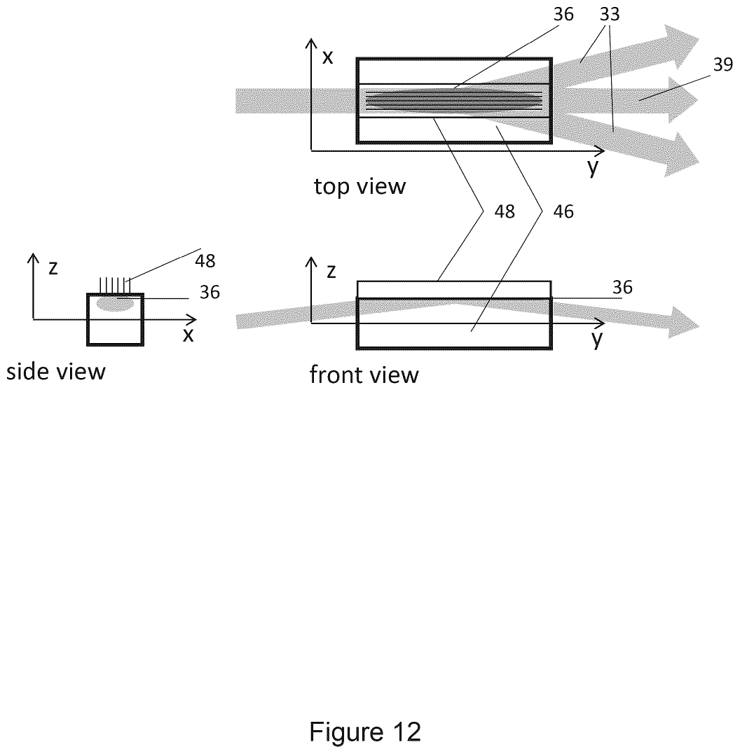

The beam scrambler prototype constructed for the purpose of proof-of-concept testing, of which geometries are illustrated in FIGS. 6a and 6b comprises an electrode assembly comprising of multiple electrodes that are separated approximately 50 μm apart. The electrodes were attached to the surface of a LiNbO₃ crystal as illustrated in FIGS. 12, and FIGS. 6a, 6b. The setup illustrated in FIG. 12 comprises an electro-optic crystal 46 which is used to scramble the beam, and an electrode assembly 48 attached to the electro-optic crystal to produce regions of strong non-uniform electric field gradient capable of scrambling the beam.

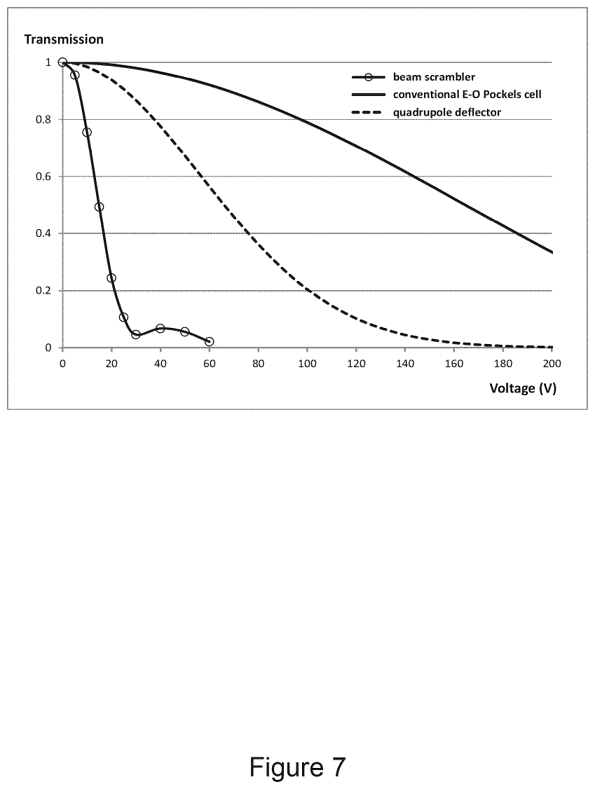

The scrambler performance was evaluated using a HeNe laser beam with beam divergence of =1.5 mrad. The far field profile of the beam emerging from the scrambler is shown in FIG. 11 for two different applied voltages: 0V (upper image) and 30V (lower image). The dashed circle is shown for a reference and represents an angle of =3 mrad. The scrambler transmission as a function of the applied voltage is presented in FIG. 7. It was derived from the captured images for the beam power, encircled within the 3 mrad circle, as illustrated in FIG. 12. We note that the apparent characteristic structure of the scattered beam, as illustrated in FIG. 11, is typical for the Raman-Nath diffraction. This suggests that the diffraction effects are dominant for this particular implementation of the beam scrambler in this case.

FIG. 7 compares the performance of the EO beam scrambler prototype with a conventional transverse Pockels cell. The graph shows the calculated single pass transmission for a Pockels cell as well as the transmission measurement results for the EO beam scrambler. For the purpose of comparison, it is assumed that the devices are based on a LiNbO₃ crystal and equidimensional (0.5 mm×0.5 mm×5 mm). The results presented in FIG. 7 demonstrate that an EO beam scrambler is suitable for low voltage Q switching, and substantially lower voltage is required for attenuating the beam.

In another aspect, the invention comprises a system for Q-switching a laser (comprising: an input pump beam; a laser cavity comprising a high reflectivity cavity mirror (HR mirror), a waveguide gain medium, a collimating material, an electro-optic “scrambler”, and an output coupler; wherein the waveguide comprises a strongly localised guiding region; wherein the input pump beam is passed through the waveguide, pumping the gain medium. When the laser is lasing, the intracavity laser beam is passed through the collimating material prior to being passed through the deflector. The output coupler is arranged such that in the presence of an applied voltage to the “scrambler”, the intracavity beam is scattered to be misaligned to the laser cavity; and wherein upon the removal of the applied voltage to the deflector, the intracavity beam becomes aligned with the output coupler producing a pulsed output beam.

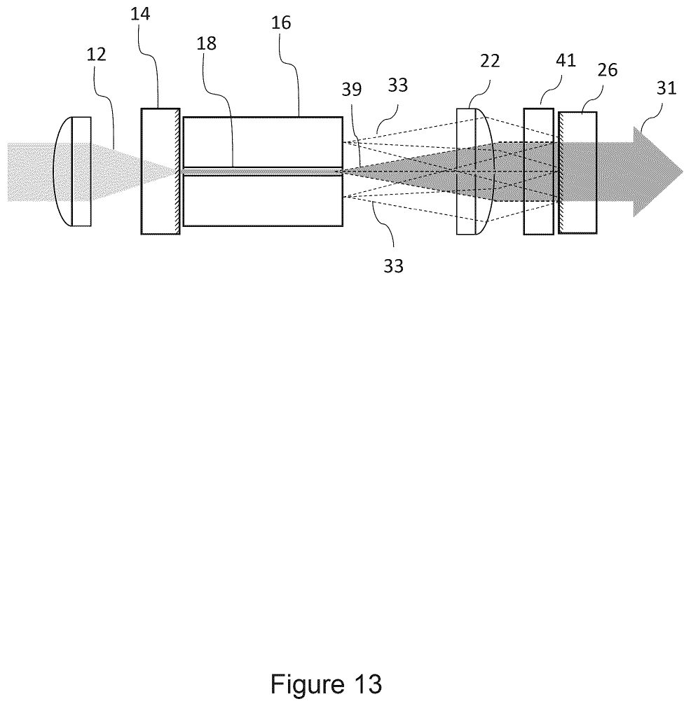

Utilising the findings of Applicant, a schematic of a laser cavity utilising a scrambling EO device 41 is illustrated in FIG. 13.

A pump diode produces a pump beam 12, which first passes through the HR cavity mirror 14 then through waveguide 16 with waveguide core 18 that acts as a strongly localised guiding region, then through collimating material 22 such as a collimating lens. The core region 18 may have a diameter of approximately 10-20 μm, although it is not limited to such as size. A voltage may be applied to scrambling EO device 41 to produce a ‘scrambled’ or scattered beam 33, misaligning the beam within the laser cavity. Upon removal of the applied voltage to the EO scrambler 41, the beam is aligned producing an aligned intracavity beam 39, which after passing through output coupler 26 produces a pulsed output beam 31.

An additional important advantage of this approach is that the beam scramblers can be constructed utilising the simplest crystal geometries and electrode arrangements (rectangular crystals and planar of flat sharp-edged electrodes). This drastically reduces device complexity and manufacturing costs. If a detachable electrode structure is utilised, it offers an additional advantage and flexibility of easily reconfigurable design.

It should be taken into consideration in the “scrambler” design that the regions of the highest electrical field and the highest field gradient are located in very close vicinity to the electrodes. The depth of such regions usually corresponds to the width of the gap between the electrodes. It is essential to have the laser beam propagating through such regions, that is as close as possible to the surfaces where the electrodes are located.

An embodiment of the present invention provides a scrambler design and a method where the interaction between the electric field and the laser beam is maximised. It is achieved by directing the laser beam through the crystal at a very small grazing angle of approximately 2-10 degrees to the crystal surface where the electrodes are located. The laser beam, which will experience the total internal reflection (TIR) from this surface, will be propagating through the regions closest to surface where the electric filed gradient is the highest. Utilising the small grazing angles is also beneficial because it maximises the “footprint” under the surface where the interaction between the light field and the electric field takes place.

Further enhancement of the proposed design can be achieved by utilising an elliptical beam profile with the major axis oriented parallel to crystal surface and aligned in such a way that the overlap between the elliptical beam profile and the area of the highest field immediately under the surface is maximised (FIG. 12).

Care should be taken when designing and constructing the EO “scrambler” to ensure that the beam reflected from the internal surface is not attenuated or affected by the electrodes, which are deposited or attached to the external crystal surface. Generally, the optical losses due to the frustrated total internal reflection (FTIR) at small grazing angles are negligible if the gap between the surface and the external objects is of same size or greater than the wavelength of light.

It is apparent that the described EO “scrambler” can be used as an optical switch or optical modulator in many other applications besides of Q-switching.

It should be noted that polarising elements, as would be known by those skilled in the art, may be introduced into the laser cavity to generate a polarised output if desired.

Furthermore, those skilled in the art would be aware that within the laser cavity, one or more than one collimating lenses may be used to achieve desired collimation of the beam. Multiple lenses may be arranged for example in a cross mounted arrangement. Such an arrangement comprising multiple lenses may be easier to mount than a single miniature lens.

The reader will now appreciate the present invention which provides a method of Q-switching a waveguide laser with an electro-optic deflector.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

What is claimed is:

1. A system for Q-switching a laser, comprising:
an input pump beam, a laser cavity comprising a highly reflective cavity mirror, a waveguide gain medium, a collimating material, an electro-optic deflector, and an output coupler;
wherein the waveguide comprises a strongly localised guiding region;
wherein the input pump beam is passed through the waveguide, thereby pumping the waveguide gain medium to produce an intracavity laser beam;
wherein the intracavity beam is then passed through the collimating material, then subsequently passed through the deflector;
wherein the output coupler is misaligned with the intracavity laser beam; and
wherein upon application of a voltage to the deflector, the intracavity beam becomes deflected to be aligned with the output coupler, thereby producing a pulsed output beam.

2. The system of claim 1, comprising a plurality of input pump beams and a plurality of waveguide gain mediums;
wherein the plurality of waveguide gain mediums produce a plurality of intracavity beams; and
wherein the plurality of intracavity beams are passed through the deflector.

3. The system of claim 2, wherein the deflector comprises a repeating pattern of electrodes, wherein each unit of the repeating pattern of electrodes are aligned with an individual intracavity beam, and wherein the plurality of intracavity beams are passed through the deflector, thereby producing an array of pulsed output lasers.

4. The system of claim 1, wherein the collimating material is one or more collimating lens.

5. The system of claim 1, wherein the collimating material is a metamaterial layer.

6. The system of claim 1, wherein the diameter of the strongly localised guiding region of the waveguide gain medium is in the order of 10 microns.

7. The system of claim 1, wherein the electro-optic deflector is a quadrupole electro-optic deflector.

8. The system of claim 7, wherein the electro-optic deflector comprises cylindrical electrodes.

9. The system of claim 7, wherein the electro-optic deflector comprises flat electrodes.

10. A system for Q-switching a laser, comprising:
an input pump beam, a laser cavity comprising a highly reflective cavity mirror, a waveguide gain medium, a collimating material, an electro-optic deflector, and an output coupler;
wherein the waveguide comprises a strongly localised guiding region;
wherein the input pump beam is passed through the waveguide, thereby pumping the waveguide gain medium to produce an intracavity laser beam;
wherein the intracavity beam is then passed through the collimating material, then subsequently passed through the deflector;
wherein the output coupler is aligned with intracavity laser beam, such that in the presence of an applied voltage to the deflector, the intracavity beam is misaligned with the laser cavity; and
wherein upon removing the applied voltage to the deflector, the intracavity beam becomes aligned with the output coupler, thereby producing a pulsed output beam.

11. The system of claim 10, comprising a plurality of input pump beams and a plurality of waveguide gain mediums;
wherein the plurality of waveguide gain mediums produce a plurality of intracavity beams; and
wherein the plurality of intracavity beams are passed through the deflector.

12. The system of claim 11, wherein the deflector comprises a repeating pattern of electrodes, wherein each unit of the repeating pattern of electrodes are aligned with an individual intracavity beam, and wherein the plurality of intracavity beams are passed through the deflector, thereby producing an array of pulsed output lasers.

13. The system of claim 10, wherein the collimating material is one or more collimating lens.

14. The system of claim 10, wherein the collimating material is a metamaterial layer.

15. The system of claim 10, wherein the diameter of the strongly localised guiding region of the waveguide gain medium is in the order of 10 microns.

16. The system of claim 10, wherein the electro-optic deflector is a quadrupole electro-optic deflector.

17. The system of claim 16, wherein the electro-optic deflector comprises cylindrical electrodes.

18. The system of claim 16, wherein the electro-optic deflector comprises flat electrodes.

19. A system for Q-switching a laser, comprising:
an input pump beam, a laser cavity comprising a highly reflective cavity mirror, a bulk gain medium, a collimating material, an electro-optic scrambler, and an output coupler;
wherein the bulk gain medium comprises a strongly localised guiding region;
wherein the input pump beam is passed through the bulk gain medium, thereby pumping the waveguide gain medium to produce an intracavity laser beam;
wherein the intracavity beam is then passed through the collimating material, then subsequently passed through the scrambler;
wherein the output coupler is aligned with intracavity laser beam, such that in the presence of an applied voltage to the scrambler, a spatial profile of the intracavity beam is scrambled within the laser cavity; and
wherein upon removing the applied voltage to the scrambler, the spatial profile of the intracavity beam is restored, thereby producing a pulsed output beam.

20. The system of claim 19, wherein the electro-optic scrambler is a rectangular electro-optic crystal, comprising planar electrodes attached to a surface of the rectangular electro-optic crystal.

21. The system of claim 19, wherein the electro-optic scrambler is a rectangular electro-optic crystal, comprising sharp edged electrodes attached to a surface of the crystal.

22. The system of claim 20, wherein the intracavity beam is passed through the electro-optic scrambler at a shallow grazing angle to the surface of the crystal that the electrodes are attached to.

23. The system of claim 21, wherein the intracavity beam is passed through the electro-optic scrambler at a shallow grazing angle to the surface of the crystal to which the electrodes are attached.

24. The system of claim 20, wherein the intracavity beam has an elliptical spatial profile, wherein a major axis of the ellipse is oriented parallel to the crystal surface where the electrodes are located.

25. The system of claim 21, wherein the intracavity beam has an elliptical spatial profile, wherein a major axis of the ellipse is oriented parallel to the crystal surface where the electrodes are located.

26. The system of claim 19, wherein the collimating material is one or more collimating lenses.

27. The system of claim 19, wherein the bulk gain medium is a waveguide gain medium.
